(19) United States
(12) Patent Application Publication
(10) Pub. No.: US 2018/0188066 A1
(43) Pub. Date: Jul. 5, 2018

(54) METHOD AND APPARATUS FOR DYNAMIC COMMUTE-TIME COMPARISON

(71) Applicant: Innovocative Solutions, LLC, Kansas City, MO (US)

(72) Inventors: Neal Shaw, Shawnee, KS (US); Hieu Truong, Centerton, AR (US); Robert James, Kansas City, MO (US); Robert DuBroc, Stilwell, KS (US); Jennifer DuBroc, Stilwell, KS (US)

(73) Assignee: Innovocative Solutions, LLC, Kansas City, MO (US)

(21) Appl. No.: 15/397,660

(22) Filed: Jan. 3, 2017

(51) Int. Cl. G01C 21/36; G01C 21/20

(52) U.S. Cl. CPC G01C 21/3667; G01C 21/3682; G01C 21/20

(57) ABSTRACT

A system and method for dynamically determining and comparing the commute-time between each of a plurality of physical locations comprises at least one communication device and a commute-time management system. The commute-time management system comprises a location determination and conversion module, a commute-time calculation module, a commute-time comparison module and a display module located at the processor. The location determination and conversion module configured to determine the location based on each of the plurality of physical locations provided by the user through the at least one communication device via a network. The commute-time calculation module configured to determine the commute-time and the commute-time comparison module configured to compare the commute-time of the first physical location with respect to each of the plurality of second physical locations. The display module configured to display the commute-time on the at least one communication device.

### BACKGROUND OF THE DISCLOSURE

### Technical Field of the Disclosure

The present embodiment relates in general to the field of commute-time determination methods and, in particular, to a method and system that determines commute-time between multiple locations and compares the commute-time of a single location with each of the multiple locations to provide instant commute-time statistics.

### Description of the Related Art

Humans are social beings and most people want to live in places close to or in nearby locations where their friends or relatives live. Before buying a property, he/she may consider different factors such as how far it is from his/her office, the distance to a nearby school, hospital, stores, recreational areas etc. It is important to consider commute-time before buying a property because commuting can be a time consuming, stressful and sometimes frustrating experience. To arrive at a final decision on which property to be purchase, and when looking at various properties, the buyer will want to compare the commute-time of each property with respect to among others, the above mentioned locations. Some existing systems and methods provide commute-time between a first location and a second location. However, such systems and methods fail to provide commute-time with respect to multiple locations.

Another important factor to be considered before purchasing property is the commute-time between the proposed property and the work location. When the distance and commute time rises, stress resulting from the commute-time increases which can contribute to dissatisfaction with the individual's job. In addition, some employers may move their business location to another location which will affect the commute-time of the employees of that business. In such situations both the employee and the employer would like to know and compare how the location change will affect their commute-time. With knowledge of the commute-time of employees, the employer can assign employees to the most convenient location. Even though some of the existing systems provide commute-time with respect to multiple locations, these systems fail to compare the commute-time between multiple locations. Such systems provide the commute-time individually and a user will need to compare them manually which is tiresome when the number of proposed locations is extremely large.

Certain existing methods fail to compare commute-times between a single location and different proposed business locations. Attempts have been made to overcome these problems by developing a system and method for analyzing commuting metrics that compare the first potential commuting metric to each of the second, third, and fourth potential commuting metrics to determine a first, second, and third comparison result, respectively. However, such systems fail to provide the average commute-time of each of the plurality of employees and the percentage of employees who would experience decreased commute time and increased commute-time with the new proposed location. Such system also fail to provide the commute-time based on a plurality of travel modes such as by vehicle, bicycle, public transit, or foot.

Therefore, there is a need for a system and method to dynamically determine and compare the commute-time between a first physical location and at least one of a plurality of second physical locations. Such a system and method would determine the commute-time of the first physical location with respect to at least one of the plurality of second physical locations by dynamically converting these locations into respective latitudes and longitudes. This system and method would display the route of travel, the commute-time between the first physical location and each of the plurality of second physical locations and a summary graph which illustrates the commute-time comparison. Such a system would allow a user to compare a current commute-time with a plurality of new proposed locations. It would also enable the user to view the average commute-time between the first physical location and at least one of the plurality of second physical locations, the percentage decrease in commute time with a new proposed location, and the percentage increase commute-time with the proposed location. Such a system would provide the commute-time based on a plurality of travel modes such as travel by vehicle, bicycle, public transit, or foot and would allow comparisons between modes of travel, such as vehicle, bicycle, public transit, or walking. Such a system would also provide a compressed listing about the details regarding change in commute-time for a plurality of employees and also allows the user to group employees based on a particular department, and provide details on the change in commute-time based on each of the plurality of new proposed locations. The present embodiment overcomes the existing shortcomings in this area by accomplishing these objectives.

### SUMMARY OF THE DISCLOSURE

To minimize the limitations found in the existing systems and methods, and to minimize other limitations that will be apparent upon the reading of this specification, the preferred embodiment of the present invention provides a system and method for dynamically determining and comparing the commute-time between each of a plurality of physical locations.

The system comprises at least one communication device and a commute-time management system. The commute-time management system is in communication with the at least one communication device via a network. The commute-time management system is remotely housed on a commute-time management server having a processor installed with a commute-time management application and coupled with a memory unit integrated with a central database. The commute-time management application is a software application implemented on the commute-time management server to determine and compare the commute-time between a first physical location and at least one of a plurality of second physical locations.

The commute-time management system comprises a location determination and conversion module, a commute-time calculation module, a commute-time comparison module and a display module located at the processor. The location determination and conversion module located at the processor is configured to determine the location based the first physical location and each of the plurality of second physical locations provided by the user through the at least one communication device. The first physical location and the plurality of second physical locations can be selected from a group consisting of: a current home address, a current work location, a new work location, a business location, a proposed business location and a new home address. The location determination and conversion module converts the locations into numeric values corresponding to the respective latitude and longitude. The commute-time calculation module located at the processor is configured to determine the commute-time between the first physical location with respect to the at least one of the plurality of second physical locations received from the user through the at least one communication device. The commute-time comparison module is configured to compare the commute-time between the first physical location with respect to each of the plurality of second physical locations. The display module located at the processor is configured to display the commute-time between the first physical location with respect to at least one of the plurality of second physical locations received from the user on the at least one communication device.

The method for dynamically determining and comparing the commute-time between the first physical location and at least one of the plurality of second physical locations includes providing a commute-time management application installed in a commute-time management system, which is in communication with at least one communication device via a network. The commute-time management application is a software application implemented on the commute-time management server to determine and compare the commute-time between the first physical location and at least one of the plurality of second physical locations. A plurality of parameters including a plurality of user names, the first physical location and the plurality of second physical locations are provided through the at least one communication device to the commute-time management application. A location is determined based the first physical location and each of the plurality of second physical locations provided by the user and the location is converted into numeric values corresponding to their respective latitudes and longitudes by a location determination and conversion module located at a processor of the commute-time management system. The commute-time between the first physical location and at least one of the plurality of second physical locations is determined by the commute-time calculation module located at the processor of the commute-time management system. The commute-time between the first physical location and each of the plurality of second physical locations is compared by the commute-time comparison module located at the processor of the commute-time management system. Finally, the commute-time, the route of travel, a summary graph which illustrates the commute-time comparison and a map view showing a plurality of potential selected locations on the at least one communication device id displayed on the at least one communication device by the display module located at the processor of the commute-time management system.

It is a first objective of the present invention to provide a system and method to dynamically determine and compare the commute-time between a first physical location and at least one of a plurality of second physical locations.

A second objective of the present invention is to provide a method and system that would determine the commute-time between the first physical location with respect to at least one of the plurality of second physical locations by dynamically converting these locations into respective latitudes and longitudes.

A third objective of the present invention is to provide a method and system that would display the route of travel, the commute-time between the first physical location and each of the plurality of second physical locations and a summary graph which illustrates the commute-time comparison.

A fourth objective of the present invention is to provide a method and system that a user may use to compare a current commute-time with a plurality of new proposed locations.

Another objective of the present invention is to provide a method and system that would enable the user to view the average commute-time between the first physical location and at least one of the plurality of second physical locations, the percentage decrease in commute time with a proposed location, and the percentage increase commute-time with the proposed location.

Yet another objective of the present invention is to provide a method and system that would provide the commute-time based on a plurality of travel modes such as travel by vehicle, bicycle, public transit, or foot and would allow comparisons between modes of travel, such as vehicle, bicycle, public transit, or on foot.

Still another objective of the present invention is to provide a method and system that would provide a compressed listing about the details regarding the change in commute-time for the plurality of employees and also allows the user to group the plurality of employees based on a particular department, and provide details on the change in commute-time based on each of the plurality of proposed locations.

These and other advantages and features of the present invention are described with specificity so as to make the present invention understandable to one of ordinary skill in the art.

### BRIEF DESCRIPTION OF THE DRAWINGS

In order to enhance their clarity and improve understanding of these various elements and embodiments of the invention, elements in the figures have not necessarily been drawn to scale. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a high level block diagram of a system for dynamically determining and comparing the commute-time between a plurality of physical locations in accordance with the preferred embodiment of the present invention;

FIG. 2 illustrates a block diagram of the system for dynamically determining and comparing the commute-time between the plurality of physical locations in accordance with the preferred embodiment of the present invention;

FIG. 3 illustrates a flowchart of a method for dynamically determining and comparing the commute-time between the plurality of physical locations in accordance with the preferred embodiment of the present invention;

FIG. 4A illustrates an exemplary screenshot of a drive times screen illustrating the commute-time of the system between a plurality of employee addresses and a plurality of work locations in accordance with the preferred embodiment of the present invention;

FIG. 4B illustrates an exemplary screenshot of a compare screen illustrating the comparison of commute-time between the plurality of employee addresses and the plurality of work locations in accordance with the preferred embodiment of the present invention;

FIG. 4C illustrates an exemplary screenshot of a map view illustrating the comparison of potential selected locations between the plurality of employee addresses and the plurality of work locations in accordance with the preferred embodiment of the present invention; and

FIG. 4D illustrates an exemplary screenshot of a compressed listing illustrating the comparison of commute-time between the plurality of employee addresses and the plurality of work locations in accordance with the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term “about” means +/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

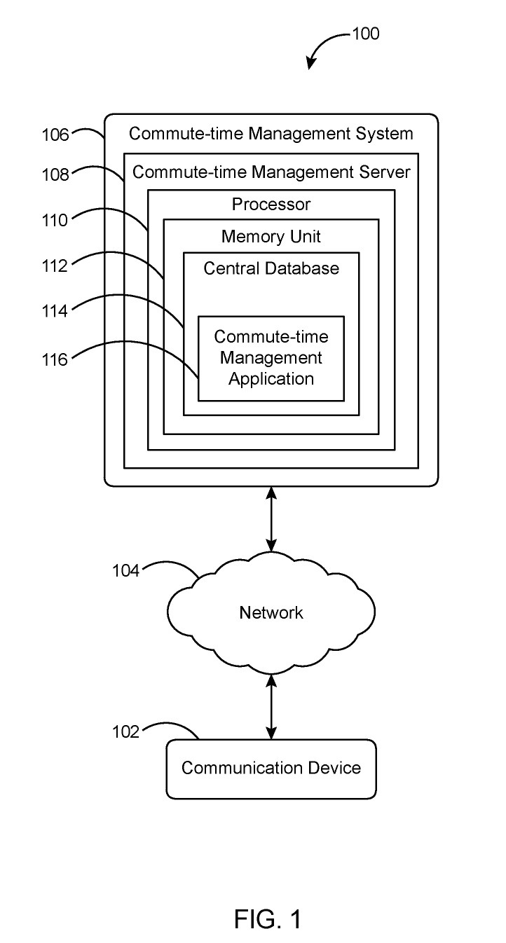

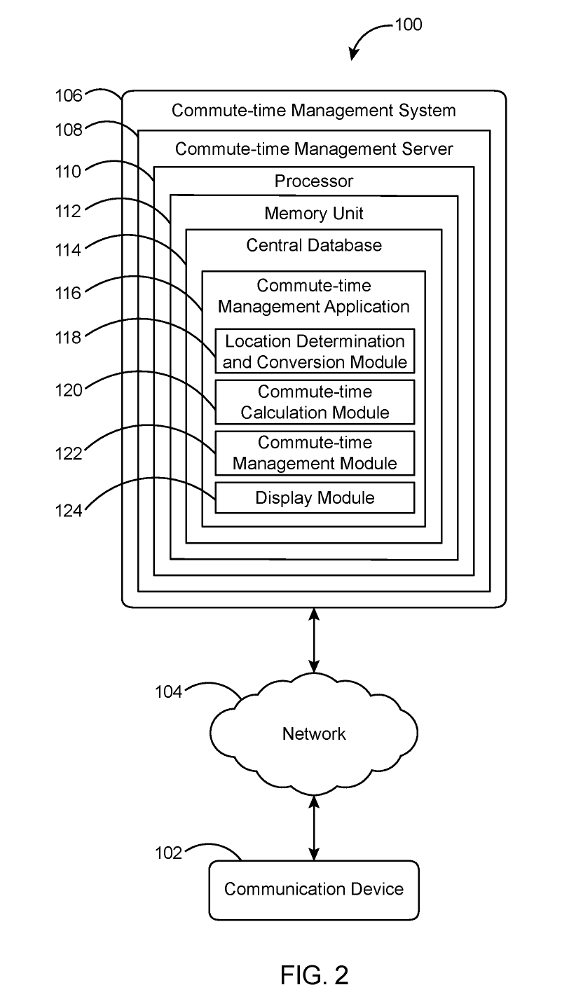

Turning first to FIGS. 1 and 2, block diagrams of a system 100 for dynamically determining and comparing the commute-time between each of a plurality of physical locations in accordance with the preferred embodiment of the present invention are illustrated. The plurality of physical locations includes a first physical location and a plurality of second physical locations. The first physical location and the plurality of second physical locations can be selected from a group consisting of: a current home address, a current work location, a new work location, a business location, a proposed business location and a new home address. The system 100 comprises at least one communication device 102 and a commute-time management system 106. The at least one communication device 102 is configured to allow a user to provide a plurality of parameters such as a plurality of user names, the first physical location and the plurality of second physical locations. The at least one communication device 102 is selected from a group consisting of: a cellular telephone, a smartphone, a wireless-enabled personal digital assistant, a tablet, a personal computer, a notebook, a smart watch and any other mobile electronic device. The commute-time management system 106 is in communication with the at least one communication device 102 via a network 104. The commute-time management system 106 is remotely housed on a commute-time management server 108 having a processor 110 installed with a commute-time management application 116 and coupled with a memory unit 112 integrated with a central database 114. The commute-time management application 116 is a software application implemented on the commute-time management server 108 to determine and compare the commute-time between the first physical location and at least one of the plurality of second physical locations. The plurality of user names, the first physical location and the plurality of second physical locations are stored in the central database 114.

The commute-time management system 106 comprises a location determination and conversion module 118, a commute-time calculation module 120, a commute-time comparison module 122 and a display module 124 located at the processor 110. The location determination and conversion module 118 located at the processor 110 is configured to determine the location based the first physical location and each of the plurality of second physical locations provided by the user through the at least one communication device 102. The location determination and conversion module 118 convert the locations into numeric values corresponding to the respective latitude and longitude. The numeric values corresponding to the respective latitude and longitude is either obtained through Global Positioning System (GPS) or is cross referenced based on the location on a map. The latitude and longitude data for any location in the world can be easily obtained from the map or from the GPS data, which will include latitude and longitude data. The commute-time calculation module 120 located at the processor 110 is configured to determine the commute-time between the first physical location with respect to the at least one of the plurality of second physical locations received from the user through the at least one communication device 102. The commute-time comparison module 122 is configured to compare the commute-time between the first physical location with respect to each of the plurality of second physical locations. The display module 124 located at the processor 110 is configured to display the commute-time between the first physical location with respect to at least one of the plurality of second physical locations received from the user on the at least one communication device 102.

In a preferred embodiment, for dynamically determining and comparing the commute-time between each of the plurality of physical locations, the user can provide the plurality of parameters including the plurality of user names, the first physical location and the plurality of second physical locations through the at least one communication device 102. The location determination and conversion module 118 determines the location based the first physical location and each of the plurality of second physical locations provided by the user. The location determination and conversion module 118 convert the locations into numeric values corresponding to the respective latitude and longitude which is either obtained through Global Positioning System (GPS) or is cross referenced based on the location on the map. The numeric values are stored in the central database 114. The commute-time calculation module 120 determines the commute-time between the first physical location with respect to the at least one of the plurality of second physical locations. The commute-time comparison module 122 compares the commute-time between the first physical location with respect to each of the plurality of second physical locations and the display module 124 located at the processor 110 display the commute-time between the first physical location with respect to at least one of the plurality of second physical locations.

The network 104 is a data communication network selected from a group consisting of: Internet, a local area network (LAN), a wide area network (WAN), wired Ethernet, wireless Ethernet and cellular wireless network. The processor 110 is an electronic circuit that executes computer programs. The memory unit 112 stores programs, applications, and data. For example, the location determination and conversion module 118, the commute-time calculation module 120, the commute-time comparison module 122 and the display module 124 of the commute-time management application 116 are stored on the memory unit 112 of the commute-time management system 106. The memory unit 112 is, for example, a random access memory (RAM) or another type of dynamic storage device that stores information and instructions for execution by the processor 110. The memory unit 112 also stores temporary variables and other intermediate information used during execution of the instructions by the processor 110. The commute-time management system 106 further comprises a read only memory (ROM) or another type of static storage device that stores static information and instructions for the processor 110. The commute-time management system 106 that executes the commute-time management application 116 communicates with the at least one communication device 102 through the network 104. The network 104 is, for example, a local area network (LAN), a wide area network, a mobile communication network, a signaling system number 7 (SS7) network, a wired telephony network, any generic data network, etc.

The commute-time management system 106 employs an operating system for performing multiple tasks. The operating system is responsible for management and coordination of activities and sharing of resources of the commute-time management system 106. The operating system further manages security of the commute-time management system 106, peripheral devices connected to the commute-time management system 106, and network connections. The operating system recognizes keyboard inputs and pointing device inputs of the user, output display, files, and directories stored. The operating system monitors the use of the processor 110. The processor 110 retrieves the instructions for executing the modules, for example, the location determination and conversion module 118, the commute-time calculation module 120, the commute-time comparison module 122 and the display module 124 of the commute-time management application 116 from the memory unit 112 in the form of signals. A program determines the location of the instructions in the memory unit 112. The program stores a number that identifies the current position in the program of the modules, for example, the location determination and conversion module 118, the commute-time calculation module 120, the commute-time comparison module 122 and the display module 124 of the commute-time management application 116.

The instructions fetched by the processor 110 from the program memory after being processed are decoded. The instructions are placed in an instruction register (IR) in the processor 110. After processing and decoding, the processor 110 executes the instructions. For example, the location determination and conversion module 118 determines the location based the first physical location and each of the plurality of second physical locations provided by the through the at least one communication device 102. The location determination and conversion module 118 defines instructions to convert the locations into numeric values corresponding to the respective latitude and longitude. The commute-time calculation module 120 defines instructions to determine the commute-time between the first physical location with respect to the at least one of the plurality of second physical locations. The commute-time comparison module 122 defines instructions to compare the commute-time between the first physical location with respect to each of the plurality of second physical locations and the display module 124 located at the processor 110 defines instructions to display the commute-time between the first physical location with respect to at least one of the plurality of second physical locations.

At the time of execution, the instructions stored in the instruction register are examined to determine the operations to be performed. The operations include arithmetic and logic operations. The processor 110 then performs the specified operations. The operating system performs multiple routines for performing a number of tasks required to assign the input devices, the output devices, and memory for execution of the modules, for example, the location determination and conversion module 118, the commute-time calculation module 120, the commute-time comparison module 122 and the display module 124 of the commute-time management application 116. The tasks performed by the operating system comprise assigning memory to the modules, for example, the location determination and conversion module 118, the commute-time calculation module 120, the commute-time comparison module 122 and the display module 124 of the commute-time management application 116, moving data between the memory unit 112 and the modules, and handling input/output operations. The operating system performs the tasks on request by the user and after performing the tasks, the operating system transfers the execution control back to the processor 110. The processor 110 continues the execution to obtain one or more outputs. The outputs of the execution of the modules, for example, the location determination and conversion module 118, the commute-time calculation module 120, the commute-time comparison module 122 and the display module 124 of the commute-time management application 116 are displayed, for example, to the user of the commute-time management application 116.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, processor cache, etc., and transmission media such as wires that constitute a system bus coupled to the processor 110, except for a transitory, propagating signal. The computer program product disclosed herein comprises one or more computer program codes for dynamically determining and comparing the commute-time between the first physical location with respect to each of the plurality of second physical locations.

In one embodiment, the commute-time management system 106 allows the user to determine and compare the commute-time between the first physical location with respect to at least one of the plurality of second physical locations. For example, the commute-time management system 106 allows the user to determine and compare the commute-time between an employee address with respect to a current business location. Further, the commute-time management system 106 allows the user to determine and compare the commute-time between the employee address with respect to a proposed business location.

In one embodiment, the commute-time management system 106 allows the user to determine and compare the commute-time between the first physical location with respect to each of the plurality of second physical locations. For example, the commute-time management system 106 allows a property buyer to determine and compare the commute-time between a current home address with respect to each of the plurality of proposed new home addresses.

In one embodiment, the commute-time management system 106 provides the commute-time based on a plurality of travel modes. The plurality of travel modes may include travel by vehicle, bicycle, public transit, or on foot.

In one embodiment, the commute-time management system 106 allows the user to edit the first physical location and at least one of the plurality of second physical locations and then the commute-time is determined with respect to the updated physical location.

In one embodiment, the display module 124 displays a map view and shows a plurality of potential selected locations. The map view allows the user to assign a selected location, to view all the potential selected location and allows the user to compare the potential selected location and with the proposed locations.

In one embodiment, for example, when a location is selected, the commute-time management system 106 provides the user with information about the average travel time for all employees to that location, as well as some other information such as the percentage of employees having a reduced commute-time to the specified location and the percentage of employees having an increased commute-time to the specified location. In one embodiment, the commute-time management system 106 provides comparison between modes of travel, such as a particular vehicle, or comparisons may be drawn between all forms of travel such as vehicle, bicycle, public transit, or on foot.

In one embodiment, the commute-time management system 106 provides a compressed listing about the details regarding change in commute-time. For instance, the commute-time management system 106 may provide a compressed listing which provides additional information about the details regarding each individual employee's change in commute-time, details about the reduced commute-time or details of increased commute-time. In one embodiment, the commute-time management system 106 allows the user to group employees based on a particular department and provides details on the change in commute-time based on each of the plurality of new proposed location.

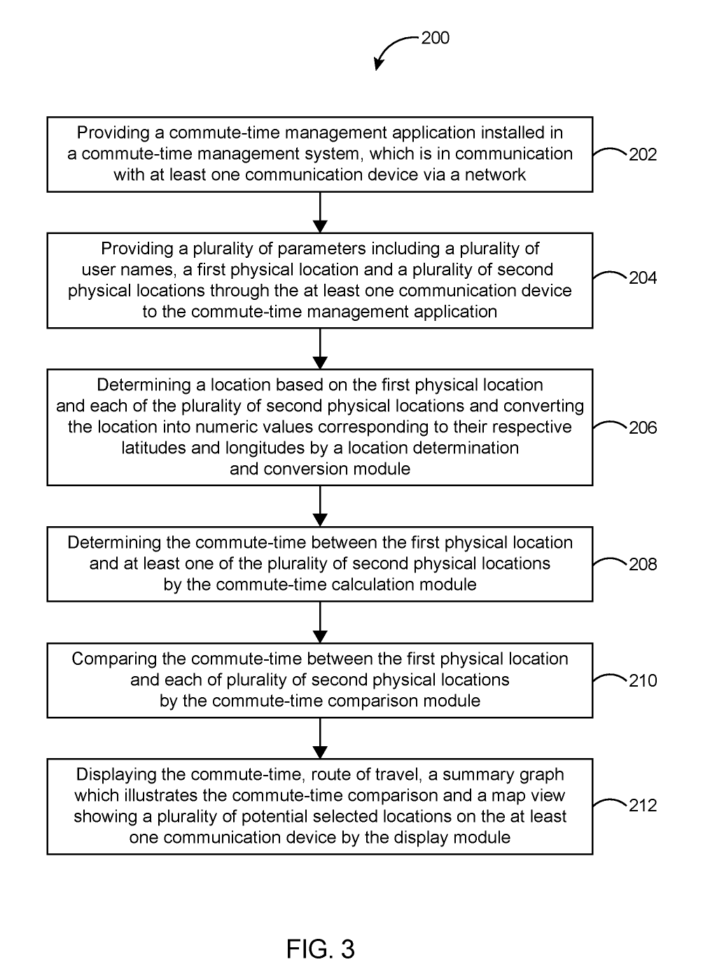

FIG. 3 illustrates a flowchart of a method for dynamically determining and comparing the commute-time between a first physical location and at least one of a plurality of second physical locations in accordance with the preferred embodiment of the present invention. The method 200 disclosed herein provides a commute-time management application installed in a commute-time management system, which is in communication with at least one communication device via a network as illustrated in block 202. The commute-time management application is a software application implemented on the commute-time management server to determine and compare the commute-time between the first physical location and each of the plurality of second physical locations. A plurality of parameters including a plurality of user names, the first physical location and a plurality of second physical locations are provided through the at least one communication device to the commute-time management application as indicated in block 204. A location is determined based on the first physical location and each of the plurality of second physical locations provided by the user and the location is converted into numeric values corresponding to their respective latitudes and longitudes by a location determination and conversion module located at a processor of the commute-time management system as indicated in block 206. The commute-time between the first physical location and at least one of the plurality of second physical locations is determined by the commute-time calculation module located at the processor of the commute-time management system as indicated in block 208. The commute-time between the first physical location and at least one of the plurality of second physical locations is compared by the commute-time comparison module located at the processor of the commute-time management system as indicated in block 210. Finally, the commute-time, the route of travel, a summary graph which illustrates the commute-time comparison and a map view showing a plurality of potential selected locations on the at least one communication device id displayed on the at least one communication device by the display module located at the processor of the commute-time management system as indicated in block 212.

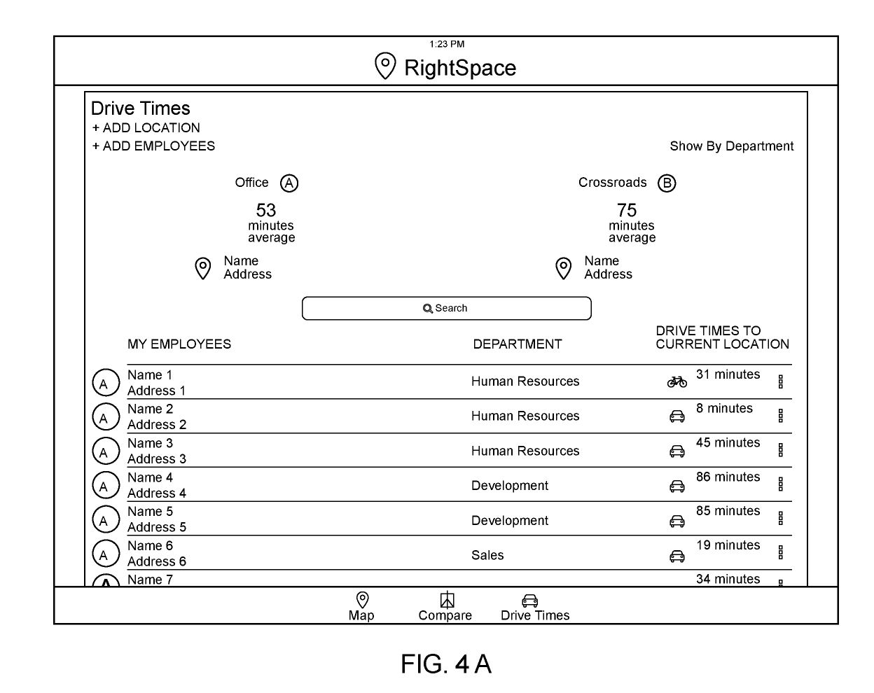

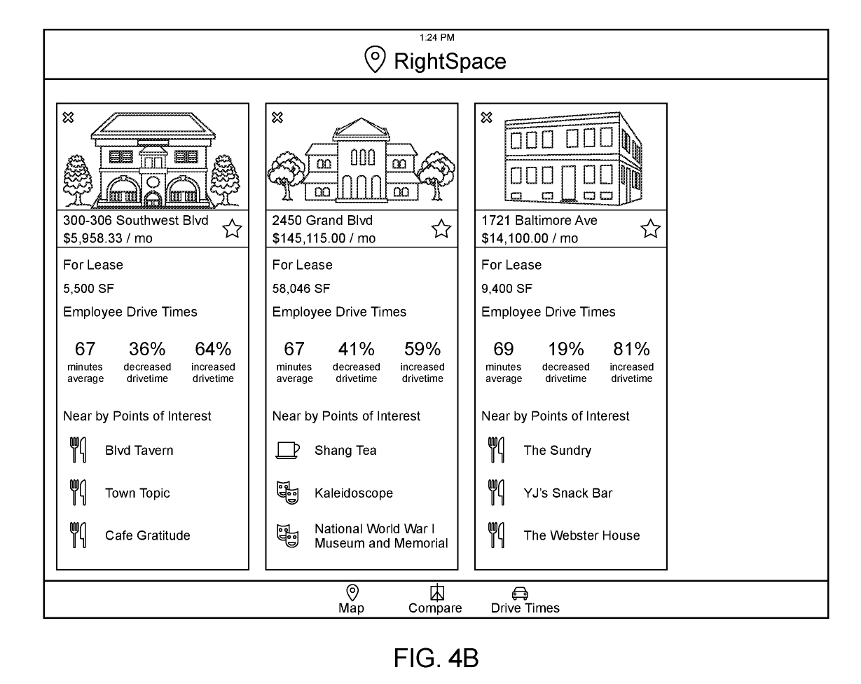

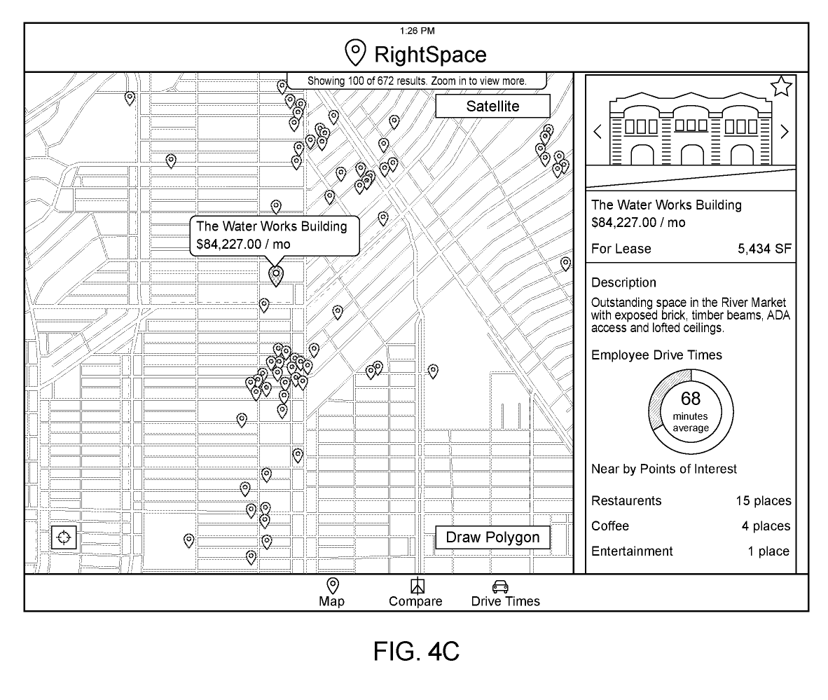

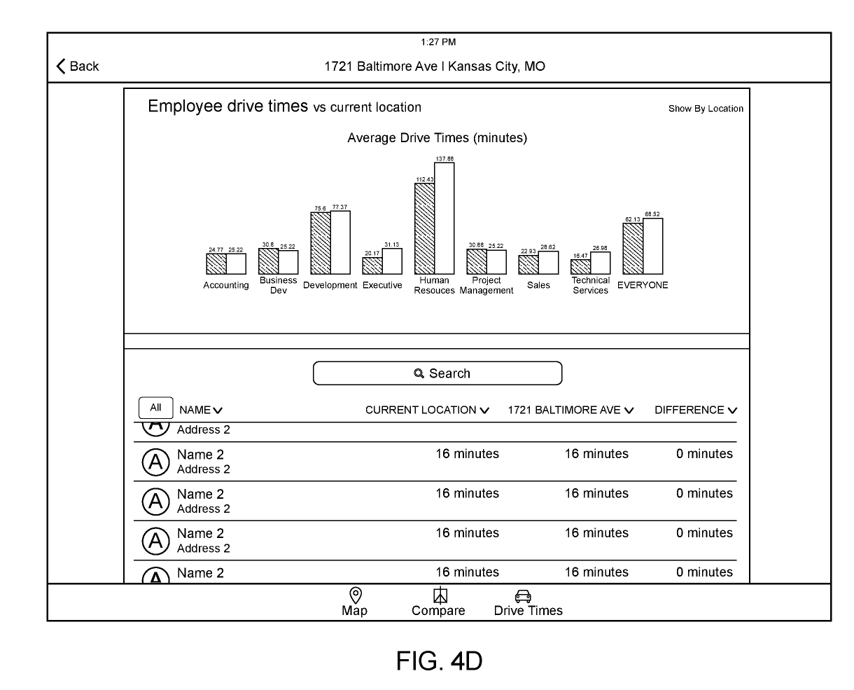

FIGS. 4A-4D illustrates exemplary screenshots of the commute-time management application 116 illustrating commute-time between a plurality of employee addresses with respect to at least one of a plurality of work locations in accordance with the preferred embodiment of the present invention. FIG. 4A illustrates an exemplary screenshot of a drive time screen illustrating the commute-time between the plurality of employee addresses and at least one of the plurality of work locations. The drive time screen illustrates the plurality of employee addresses and the average commute-time to a first selected location (A) or a second selected location (B) from the each of the plurality of employee addresses. Each of the plurality of employee addresses, the selected location, the mode of travel, for example, the first instance shows a bike, the other five show cars, and the commute-time is shown in FIG. 4A. The commute-time management application 116 further allows the user to add additional locations and more employees. At top left of the drive time screen there are two “+” signs with the first one enabling the user to add additional locations and the second one enabling the user to add additional employees. The commute-time management application 116 allows the user to edit the first selected location (A) and the second selected location (B). The drive time screen provides commute-time of the plurality of employee addresses with respect to either the first selected location (A) and the second selected location (B). A compare button at the bottom of the drive time screen provides a compare screen as illustrated in FIG. 4B.

The compare screen provides the comparison of commute-time between the plurality of employee addresses and the plurality of work locations. The compare screen allows the user to compare the commute-time of preferably, three selected locations against the average commute-time for the plurality of employee addresses currently. The compare screen compares each of the plurality of employees' current commute-time with respect to a currently selected location and to a proposed location. The compare screen provides the average commute-time for the plurality of employees, the percentage of decreased commute-time with the proposed location, and the percentage of increased commute-time with the proposed location. A map button at the bottom of the compare screen provides a map view as illustrated in FIG. 4C.

FIG. 4C illustrates an exemplary screenshot of the map view illustrating the comparison of a plurality of potential selected locations between the plurality of employee addresses and the plurality of work locations in accordance with the preferred embodiment of the present invention. The plurality of potential selected locations is shown in the map view. At least one of the plurality of potential selected locations can be either assigned as the first selected location (A) or the second selected location (B) and can be used for a comparison with respect to proposed location.

When a location for example, is selected, the map view provides the average commute-time for each of the plurality of employees to that selected location, as well as some other information about the selected location such as nearby places of interest. In the example described, the average commute-time for each of the plurality of employees to that selected location is 68 minutes. The circle around the number “68” reflects the percentage of employees having a reduced drive time to the selected location and the percentage of employees having an increased drive time to the selected location. In this exemplary embodiment, if the user taps the plain portion of the circle, the commute-time management application 116 will provide the percentage of employees with reduced commute-time and if the user taps the shaded portion of the circle, the commute-time management application 116 will provide the percentage of employees with increased commute-time. A drive times button on the bottom of the map view will provide the drive time screen as illustrated in FIG. 4A. The “show by department” button on the top of the drive time screen provides a compressed listing of the comparison of commute-time as illustrated in FIG. 4D.

FIG. 4D illustrates an exemplary screenshot of the compressed listing illustrating the comparison of commute-time between the plurality of employee addresses and the plurality of work locations in accordance with the preferred embodiment of the present invention. The commute-time management application 116 provides the user with a listing, which removes the map from the screen and provides additional information about a full listing including details regarding the commute-time of each of the plurality of employees and the change in commute-time. In one embodiment, the “show by department” button provides the breakdown of commute-time based on the departments of each of the plurality of employees. For instance, Human Resources employees, on average, would experience longer travel times, while Project Management employees would experience reduced travel times.

In one embodiment, a non-transitory computer-readable medium comprises computer-executable instructions stored therein for causing a computer to implement a program executable on the commute-time management system to determine and compare the commute-time between the first physical location and each of the plurality of second physical locations. The non-transitory computer readable storage medium comprises a USB memory, CD-ROM, flexible disc, DVD or a flash memory. In one embodiment, a non-transitory computer-readable medium comprises computer-executable instructions stored therein for causing mobility solutions to implement a program executable on the commute-time management system that enables to perform different locations based commute-time calculation utilizing the commute-time management application.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

It should also be understood that logic codes, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

Certain embodiments are disclosed with reference to flowchart illustrations or block diagrams of methods, systems and computer program products according to embodiments. It will be understood that each block of the flowchart illustrations or block diagrams, and combinations of blocks in the flowchart illustrations and/or block diagrams, may be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that may direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowcharts and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A system for dynamically determining and comparing the commute-time between a plurality of physical locations, the system comprising:
at least one communication device being configured to allow a user to provide a plurality of parameters including a plurality of user names, a first physical location and a plurality of second physical locations; and
a commute-time management system being in communication with the at least one communication device via a network, the commute-time management system including a commute-time management server residing on a central computer having a processor installed with a commute-time management application and coupled with a memory unit integrated with a central database, the commute-time management system comprising:
a location determination and conversion module located at the processor, being configured to determine the location based on the first physical location and each of the plurality of second physical locations provided by the user through the at least one communication device, the location determination and conversion module convert the locations into numeric values corresponding to the respective latitude and longitude;
a commute-time calculation module located at the processor, being configured to determine the commute-time between the first physical location with respect to the at least one of the plurality of second physical locations received from the user through the at least one communication device;
a commute-time comparison module located at the processor, being configured to compare the commute-time between the first physical location with respect to at least one of the plurality of second physical locations; and
a display module located at the processor, being configured to display the commute-time between the first physical location with respect to at least one of the plurality of second physical locations received from the user on the at least one communication device.

2. The system of claim 1 wherein the at least one communication device is selected from a group consisting of: a cellular telephone, a smartphone, a wireless-enabled personal digital assistant, a tablet, a personal computer, a notebook, a smart watch and any other mobile electronic device.

3. The system of claim 1 wherein the first physical location and the plurality of second physical locations is selected from a group consisting of: a current home address, a current work location, a new work location, a business location, a proposed business location and a new home address.

4. The system of claim 1 wherein the display module configured to display the route of travel, a summary graph which illustrates the commute-time comparison, a map view showing a plurality of potential selected locations and allows the user to compare each of the plurality of potential selected locations with a proposed location.

5. The system of claim 1 wherein the network is a data communication network selected from a group consisting of: Internet, a local area network (LAN), a wide area network (WAN), wired Ethernet, wireless Ethernet and cellular wireless network.

6. The system of claim 1 wherein the commute-time comparison module provides the user with the average commute-time of each of the plurality of user names, the percentage of users with decreased commute time and the percentage of users with increased commute-time with respect to at least one of the plurality of second physical locations.

7. The system of claim 1 wherein the commute-time is based on a plurality of travel modes selected from a group consisting of: travel by vehicle, bicycle, public transit and on foot.

8. The system of claim 7 wherein the commute-time comparison is provided between each of the plurality of travel modes.

9. A method for dynamically determining and comparing commute-time between a first physical location and at least one of a plurality of second physical locations, the method comprising the steps of:
a) providing a commute-time management application installed in a commute-time management system, which is in communication with at least one communication device via a network;
b) providing a plurality of parameters including a plurality of user names, the first physical location and the plurality of second physical locations through the at least one communication device to the commute-time management application;
c) determining a location based on the first physical location and each of the plurality of second physical locations provided by the user and converting the location into numeric values corresponding to their respective latitudes and longitudes by a location determination and conversion module located at a processor of the commute-time management system;
d) determining the commute-time between the first physical location and at least one of the plurality of second physical locations by the commute-time calculation module located at the processor of the commute-time management system;
e) comparing the commute-time of between the first physical location and each of the plurality of second physical locations by the commute-time comparison module located at the processor of the commute-time management system; and
f) displaying the commute-time, route of travel, a summary graph which illustrates the commute-time comparison and a map view showing a plurality of potential selected locations on the at least one communication device by the display module located at the processor of the commute-time management system.

10. The method of claim 9 wherein the at least one communication device is selected from a group consisting of: a cellular telephone, a smartphone, a wireless-enabled personal digital assistant, a tablet, a personal computer, a notebook, a smart watch and any other mobile electronic device.

11. The method of claim 9 wherein the first physical location and the plurality of second physical locations is selected from a group consisting of: a physical home address, a current work location, a new work location, a business location, a proposed business location and a new home address.

12. The method of claim 9 wherein the network is a data communication network selected from a group consisting of: Internet, a local area network (LAN), a wide area network (WAN), wired Ethernet, wireless Ethernet and cellular wireless network.

13. The method of claim 9 wherein the method allows the user to edit the first physical location and the plurality of second physical locations and then the commute-time is determined with respect to the updated location.

14. A computer program product comprising computer executable instructions embodied in a non-transitory computer readable storage medium having a computer readable program code embodied therein, the computer readable program code configured to be executed on a computer system to implement a method for dynamically determining and comparing commute-time between a first physical location and a plurality of second physical locations via a network, the method comprising the steps of:
a) providing a plurality of parameters including a plurality of user names, the first physical location and the plurality of second physical locations through the at least one communication device by a user via a commute-time management application installed in a commute-time management system;
b) determining a location based the first physical location and each of the plurality of second physical locations provided by the user and converting the location into numeric values corresponding to their respective latitudes and longitudes by a location determination and conversion module located at a processor of the commute-time management system;
c) determining the commute-time between the first physical location and at least one of the plurality of second physical locations by the commute-time calculation module located at the processor of the commute-time management system;
d) comparing the commute-time of between the first physical location and each of the plurality of second physical locations by the commute-time comparison module located at the processor of the commute-time management system; and
e) displaying the commute-time, route of travel, a summary graph which illustrates the commute-time comparison and a map view showing a plurality of potential selected locations on the at least one communication device by the display module located at the processor of the commute-time management system.

15. The computer program product of claim 14 wherein the at least one communication device is selected from a group consisting of: a cellular telephone, a smartphone, a wireless-enabled personal digital assistant, a tablet, a personal computer, a notebook, a smart watch and any other mobile electronic device.

16. The computer program product of claim 14 wherein the first physical location and the plurality of second physical locations is selected from a group consisting of: a physical home address, a current work location, a new work location, a business location, a proposed business location and a new home address.

17. The computer program product of claim 14 wherein the network is a data communication network selected from a group consisting of: Internet, a local area network (LAN), a wide area network (WAN), wired Ethernet, wireless Ethernet and cellular wireless network.

18. The computer program product of claim 14 wherein the method allows the user to edit the first physical location and the plurality of second physical locations and then the commute-time is determined with respect to the updated location.
